(19) United States
(12) Patent Application Publication
(10) Pub. No.: US 2005/0182686 A1
(43) Pub. Date: Aug. 18, 2005

(54) Apparatus and method for order confirmation

(76) Inventor: Shotatsu Yo, Kobe-shi (JP)

Correspondence Address: HARNESS, DICKEY & PIERCE, P.L.C., P.O. BOX 8910, RESTON, VA, 20195, US

(21) Appl. No.: 11/045,254

(22) Filed: Jan. 31, 2005

(30) Foreign Application Priority Data
Jan. 30, 2004 (JP) P2004-24085

(51) Int. Cl. G06F 17/60

(52) U.S. Cl. 705/26

(57) ABSTRACT

The invention provides an apparatus and method for order confirmation, which can easily recognize order information of ordered item. Specifically the apparatus includes a memory which stores a program list of a program in which the item is introduced and item information in accompaniment with the order of the item, and a display capable of outputting program addition information and information of the ordered item stored in the memory.

### BACKGROUND OF THE INVENTION

1, Field of the Invention

The present invention relates to apparatus and method for order confirmation applicable to a digital broadcasting receiving apparatus or the like.

2, Description of the Prior Art

Heretofore, there has been proposed techniques which are capable of efficiently ordering an item which is introduced on television. For instance, Japanese Unexamined Patent Publication JP-A 10-75431 (1998) discloses a technique of storing broadcasted contents, namely information for ordering an item, and of enabling to order the item after the broadcasting.

Recently, there has been increasingly pervasive of digital broadcasting capable of realizing images and sounds of higher quality than those of analog broadcasting, and multifunctional broadcasting. A digital broadcasting receiving apparatus which is capable of receiving the digital broadcasting as described above uses data transmission facilities with the use of broadcast waves, information input and communication facilities which are incorporated in the receiving apparatus. Therein, an interactive service which allows a television viewer to take some actions to a broadcaster (for instance, ordering item) has been put to practical use.

The technique disclosed in Japanese Unexamined patent Publication JP-A 10-7543 (1998) and the digital broadcasting receiving apparatus described above have the following problems because it takes days until an item is delivered to an orderer after the orderer ordered the item. When an item is delivered, the orderer may forget what item the orderer ordered and what quantity the orderer ordered. Further, when they make an inquiry about the delivered item, the inquiry may not effectively proceed without order information. Also it causes a similar problem when making an inquiry before the item is delivered.

### SUMMARY OF THE INVENTION

An object of the invention is to provide apparatus and method for order confirmation capable of easily recognizing order information of an item.

The invention provides an order confirmation apparatus comprising:

receiving means for receiving broadcast waves containing program addition information added to a program to be provided;

item ordering means for ordering an item which is introduced in a program on the broadcast waves received by the receiving means;

storing means for storing the program addition information for the program in which the item is introduced and information of the item in accompaniment with order of the item, by the item ordering means; and

output means capable of outputting the program addition information stored in the storing means and information of the ordered item.

According to the invention, the receiving means receives broadcast waves containing the program addition information added to a program to be provided. The item introduced in the program of the broadcast waves received by the receiving means is ordered by the item ordering means. The storing means stores the program addition information for the program in which the item is introduced, and the information of the item, in accompaniment with order of the item. The program addition information stored in the storing means and the information of the ordered item can be outputted by the output means.

Further, in the invention, it is preferable that the information of the item includes an order quantity of the item.

According to the invention, with the order quantity of the item in the information of the item, the orderer can confirm whether the quantity of the delivered item is correct or not by recognizing the information of the item outputted by the output means.

Further, in the invention, it is preferable that the information of the item further includes an inquiry address about the item.

According to the invention, when it is necessary to make an inquiry about unclear points, breakdowns and others of the ordered item, it is possible to give a quick access to the inquiry address.

Further, in the invention, it is preferable that the program addition information includes a name of a broadcasting station, a broadcasting date and broadcasting hours.

According to the invention, it is possible to confirm the name of the broadcasting station, the broadcasting date and the broadcasting hours of the program in which the item is ordered, and to recognize the ordered item so as not to forget.

Further, the invention provides an order confirmation method comprising:

an item ordering step of receiving broadcast waves containing program addition information added to a program to be provided and ordering an item introduced in the program of the received broadcast waves;

a storing step of storing the program addition information of the program introducing the item, and information of the item, in accompaniment with order of the item at the item ordering step; and

an outputting step of outputting the program addition information and information of the ordered item stored at the storing step.

According to the invention, the item introduced in the program of the received broadcast waves is ordered at the item ordering step. At the storing step, in accompaniment with order of the item at the item ordering step, the program addition information of the program introducing the item and the information of the item are stored. At the outputting step, the program addition information and the information of the ordered item which are stored are outputted.

According to the invention, every time the item is ordered, the storing means stores the program addition information of the program introducing the item and the information of the item. It is possible to output the program addition information and the information of the ordered item stored by the storing means by the output means. Thus, at the storing means, every time the item is ordered, the information of the item and the program addition information for the program is stored automatically, and it is possible for an orderer to eliminate troubles that the orderer writes down all the information of the item and the program addition information or the like, and moreover, to obtain the information most surely without fail.

In addition, after the item is ordered, it is possible to output the information of the item and the program addition information for the program at any time. Therefore, the orderer can recognize the order information of the ordered item until the item is delivered or when the item is delivered. Since the information of the ordered item can be recognized by outputting it at any time, even when a mistake in an order placement of the item by the orderer is found, it is possible to cancel the order of the item without delay. Even when a mistake in an order placement of the item by a item provider is found, it is possible to recognize the order mistake by comparing the information of the ordered item and the actual item.

Further, according to the invention, since the information of the item includes the order quantity of the item, the orderer can confirm whether the quantity of the delivered item is correct or not by recognizing the information of the item outputted by the output means.

Further, according to the invention, when it is necessary to make an inquiry about unclear points, breakdowns and others of the ordered item, it is possible to give a quick access to an inquiry address.

Further, according to the invention, it is possible to prevent the ordered item from being forgotten by confirming a name of a broadcasting station, a broadcasting date and broadcasting hours and recognizing the ordered item.

Further, according to the invention, at the storing step, in accompaniment with order of the item at the item ordering step, the program addition information for the program introducing the item and the information of the item are stored. At the outputting step, it is possible to output the program addition information and the order information of the ordered item being stored. Thus, at the storing step, in accompaniment with order of the item, the information of the item and the program addition information of the item are stored automatically, and it is possible for the orderer to eliminate troubles that the orderer writes down all the information of the item and the program addition information, and moreover, to obtain the information most surely without fail.

In addition, after the item is ordered, it is possible to output the information of the item and the program addition information for the program at any time. Therefore, the orderer can recognize the order information of the ordered item until the item is delivered or when the item is delivered. Since the information of the ordered item can be outputted and recognized at any time, even when a mistake for the order placement of the item by the orderer is found, it is possible to cancel the order of the item without delay.

### BRIEF DESCRIPTION OF THE DRAWINGS

Other and further objects, features, and advantages of the invention will be more explicit from the following detailed description taken with reference to the drawings wherein:

FIG. 1 is a block diagram schematically illustrating an electric structure of a digital broadcasting receiving apparatus of an embodiment of the invention;

FIG. 2 is a block diagram illustrating an electric structure of a receiver;

FIG. 3 is a diagram illustrating one example of a item purchase screen or a screen for storing a item;

FIG. 4 is a diagram illustrating an order confirmation screen, which is one example of a screen wherein an order list is displayed;

FIG. 5 is a diagram illustrating one example of a screen wherein order contents in detail are displayed;

FIG. 6 is a diagram illustrating one example of a questionnaire/opinion sending screen;

FIG. 7 is a flowchart illustrating a preparatory operation of a CPU for transiting to a item order method;

FIG. 8 is a flowchart illustrating an operation of the CPU to order a item;

FIG. 9 is a flowchart illustrating an operation for transiting to an information conservation method of the CPU;

FIG. 10 is a flowchart illustrating an operation of the CPU to save obtained data in memory;

FIG. 11 is a flowchart illustrating an operation of the CPU to display conservation data;

FIG. 12 is a flowchart illustrating another operation of the CPU to display the conservation data;

FIG. 13 is a flowchart illustrating an operation of the CPU to send information to an inquiry address; and

FIG. 14 is a block diagram schematically illustrating an electric structure of the digital broadcasting receiving apparatus of another embodiment of the invention.

### DETAILED DESCRIPTION OF THE PREFERED EMBODIMENTS

Now referring to the drawings, preferred embodiments of the invention are described below.

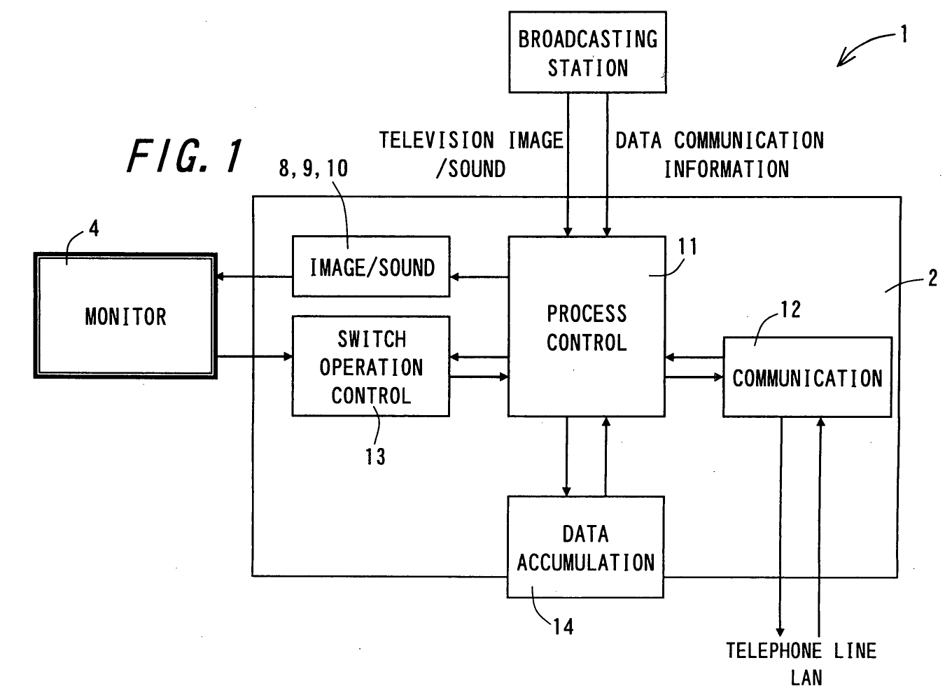

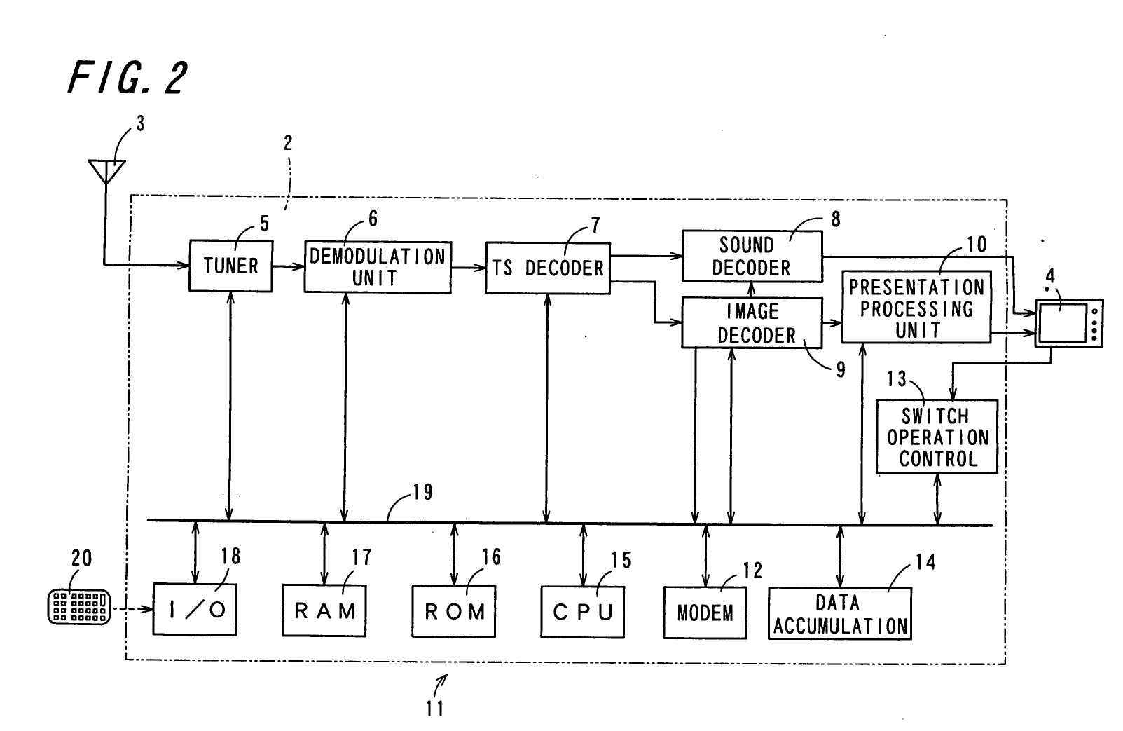

FIG. 1 is a block diagram schematically illustrating an electric structure of a digital broadcasting receiving apparatus 1 of an embodiment of the invention. FIG. 2 is a block diagram illustrating an electric structure of a receiver 2. The digital broadcasting receiving apparatus 1 corresponds to an order confirmation apparatus. The following explanation also includes a description of an order confirmation method. The digital broadcasting receiving apparatus 1 is configured to be able to receive digital broadcast waves sent from a broadcasting station. The digital broadcast waves include, for instance, at least either digital terrestrial broadcasting or satellite digital broadcast waves. The digital broadcasting receiving apparatus may be fixed to a prescribed position. It may also be loaded for use onto a movable body such as a vehicle, an aircraft and a vessel.

In the digital broadcasting, signals such as television images and sounds signals are sent collectively as one signal. When the signal is sent, out of internationally-established compression techniques of color moving images by MPEG (moving picture experts group), a compression technique of color moving images called MPEG2 is used. MPEG2 allows coded images, sounds or the like to be packetized and sent as a single signal in the form of fixed-length TS (transport stream) signal suitable for transmission. The TS signal includes a program containing information about contents of a program such as service information and program specification information, and table information representing a relation of data constituting the program. The data constituting the program includes images for television broadcasting, sounds for television broadcasting and data for data broadcasting.

The digital broadcasting receiving apparatus 1 is provided with a receiver 2, an antenna 3, a speaker (not shown) and a display 4. The display 4 is represented as “MONITOR” in FIG. 1. The receiver 2 is provided with a tuner 5, a demodulation unit 6, a TS (transport stream) decoder 7, a sound decoder 8, an image decoder 9, a presentation processing unit 10, a processing control unit 11, a modem 12, a switch operation control unit 13, and a memory 14. The processing control unit 11 is provided with a central processing unit 15 (abbreviated as CPU), a ROM 16 (Read Only Memory), a RAM 17 (Random Access Memory), an input/ output interface 18 (abbreviated as I/O), and a system bus 19.

The antenna 3 acquires a digital broadcasting wave sent from at least one of a broadcasting satellite, a communication satellite and a terrestrial antenna. The receiver 2 extracts image data and sound data of each digital-broadcast program, respectively, synchronization of images and sounds is carried out with the image data and sound data extracted. Then, the receiver 2 may display images of a program and output sounds of the program simultaneously. The speaker has functions to receive sound signals generated by the sound decoder 8, convert them to sounds, and output the converted sounds. The display 4 has a function to display images based on image signals generated by the image decoder 9.

In the receiver 2, the tuner 5 selects and receives one digital broadcasting wave of a channel from plural digital broadcasting waves acquired by the antenna 3. The demodulation unit 6 demodulates the digital broadcasting waves of the channel selected. The TS decoder 7 extracts information such as images and sounds multiplexed on the TS signals. The sound decoder 8 has functions to generate sound signals by decoding signals including the sound data extracted from program signals. Then, sounds of a digital-broadcast program may be outputted from the speaker. The image decoder 9 has functions to generate image signals by decoding signals including the image data extracted from program signals. Then, images of a digital-broadcast program may be displayed on the display 4 as output means. The presentation processing unit 10 applies image processing to the image data generated by the image decoder 9 . The presentation processing unit 10 has functions to control the display 4 by receiving signals pertaining to a display outputted from the CPU 15.

The system bus 19 is connected electrically to the tuner 5, the demodulation unit 6, the TS decoder 7, the image decoder 9, the presentation processing unit 10, the CPU 15, the ROM 16, the RAM 17, the I/O 18, the modem 12, the memory 14, and the switch operation control unit 13. The CPU 15 controls hardware resources based on commands from a program previously stored in the ROM 16 and from the switch operation control unit 13. The hardware resources include the tuner 5, the demodulation unit 6, the TS decoder 7, the sound decoder 8, the image decoder 9, the presentation processing unit 10, the system bus 19, the ROM 16, the RAM 17, the I/O 18, the modem 12, and the memory 14. The display 4 is provided with a touch panel or the like. By operating the touch panel, the switch operation control unit 13 executes controls according to the switch operation. The switch operation control unit 13 is constructed to output command signals according to the operator's commands, and give the command signals to the CPU 15. That is, the switch operation control unit 13 determines whether a predetermined switch is operated or not. The CPU 15 of the processing control unit 11 controls to execute programs related to the switch when the switch operation control unit 13 determines the switch as being operated.

In the processing control unit 11, the ROM 16 stores a program or the like for performing at least one of a program for image processing, the item order, and the information conservation. The RAM 17 temporarily stores results of arithmetic processing by the CPU 15. Further, the RAM 17 stores category information inputted with the use of a remote control 20 by the operator, that is, stored is information representing program sorts such as news, sports, music, drama, and mail-order programs. The I/O interface 18 is an input output interface to transmit the operator's commands to the CPU 15 through the system bus 19. In other words, when a remote control 20 is operated by the operator, the I/O 18 outputs command signals according to the operator's commands and gives the command signals to the CPU 15.

The system bus 19 is electrically connected to the modem 12. The receiver 2 is constructed to be able to electrically connect to, for instance, external telephone lines by the modem 12. Then, the receiver 2 may access a network connected to the communication lines such as Internet. Via these telephone lines or the like, the operator can order the item introduced in a program. An item order procedure and a procedure of referring to purchase history are described below. The remote control 20 is input means of remote operation for sending commands to the receiver 2 by wireless communication. The remote control 20, the I/O 8, the CPU 15, and the modem 12 correspond to item order means. The modem 12 and communication lines correspond to communication means.

The digital broadcasting has an electronic program guide (abbreviated as EPG) function. The EPG is a service provided from a broadcasting station in order to provide assistance for an action of selecting a program. That is, it is possible for the operator, based on the service provided from the broadcasting station, to select a program subjected to watching and recording with the use of the remote control 20 or the like while watching a television display. The EPG function is realized on the basis of text information transmitted by program placement information included in the TS signals. The text information includes a program listing, program guidance information, item information or the like. The program listing includes information on channels, start times, durations, program titles, category or the like. The program guidance information includes cast members, creators or the like. The item information includes a company introducing item, an inquiry address after ordering or the like. The program listing corresponds to program addition information. The item information corresponds to information of the item introduced in a program.

The memory 14 as storing means is realized by a hard disc drive (abbreviated as HDD) or the like. The memory 14 stores, in accompaniment with order of an item, the program listing of the program in which the item is introduce, and the item information. A control main constituent for this is the CPU 15. In the embodiment, the memory 14 as storing means is realized by a hard disc drive, but it is not necessarily limited to a hard disc drive. The storing means can be realized by an external memory such as an ST card, or a nonvolatile memory in a television or the like. Additionally, such an embodiment is also possible in which the external memory such as the hard disc drive and the ST card, and the nonvolatile memory in the Television are used selectively.

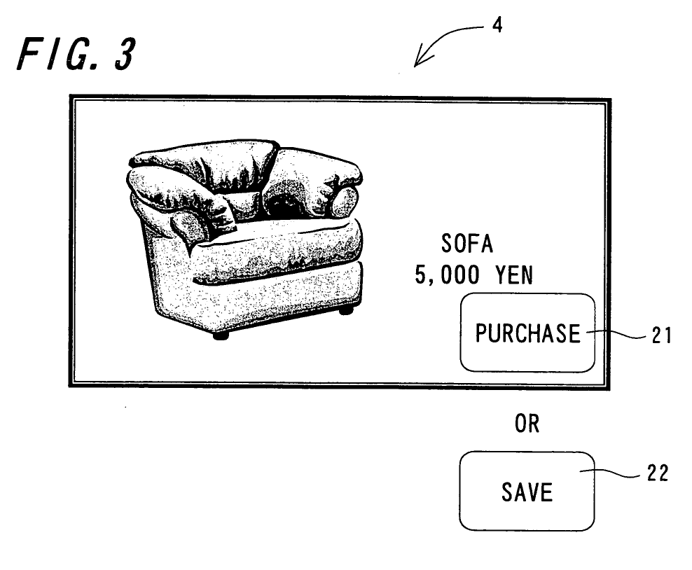

FIG. 3 represents one example of item purchase screen or screen for saving an item. The digital broadcasting receiving apparatus 1 is constructed to be able to purchase an item introduced in a mail-order program provided by a broadcasting station or save the information of the item and the like by the operator's operation. Specifically, during or after broadcasting of the mail-order program, by operator's operation, for instance, a “main menu” screen is displayed in the display 4. This kind of display screen can be displayed either on the whole display 4 or on a part of the display 4. The former type of display screen, namely, the display screen displayed on a part of the display 4 enables to order an item while watching the mail-order program or the like.

For instance, on the condition that the main menu screen is displayed, it is possible for the operator to select an order menu. On the condition that the order menu is selected, it is possible to order or save the intended item. That is, a purchase switch 21 on the touch panel is pressed by the operator, and it is possible to save the information in the memory 14 and to order the intended item simultaneously. A control main constituent for this is the CPU 15. The information to be saved in the memory 14 includes a present time and date, a name of a broadcasting station, item information and additional information as information of the item, or the like. The present time and date means year, month, day and hours at ordering point. The item information includes information of the item itself such as a sofa, and information of order quantity of the item. The additional information includes at least one of a telephone number for inquiry, a URL address (that is, homepage address) for inquiry, and a mail address for inquiry. For saving the item information of the intended item, the additional information, the present time and date, and the name of the broadcasting station in the memory 14 once, the operator pushes a saving switch 22 on the touch panel on the condition that the ordering menu is selected. Then, it is possible to save the item information of the intended item, the additional information, the present time and date, and the name of the broadcasting station in the memory 14. Incidentally, in the case of an apparatus mounted on a car, by using the position information from a navigation apparatus, order position information is also saved and can be used for display or the like thereafter similarly as other information.

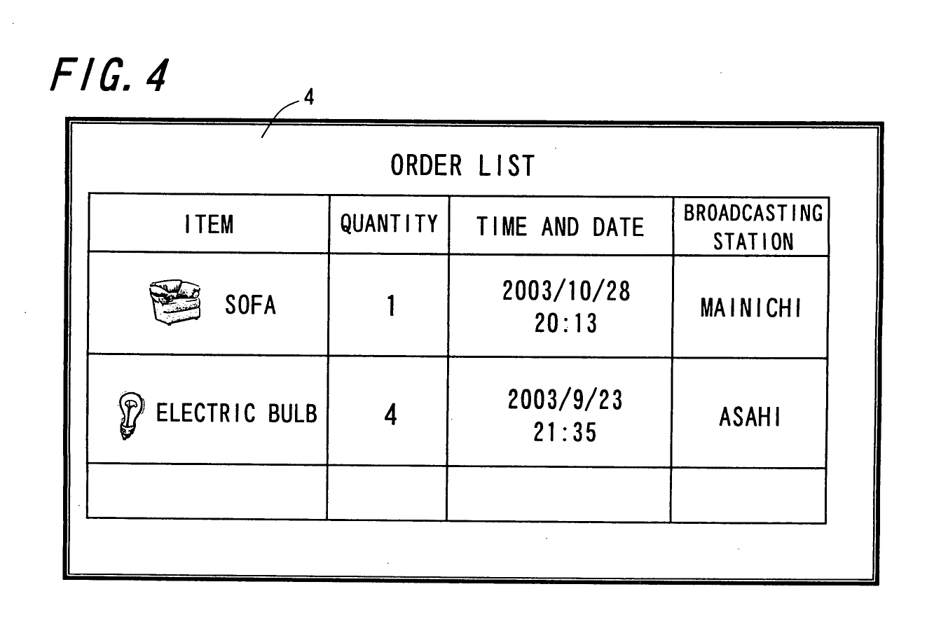

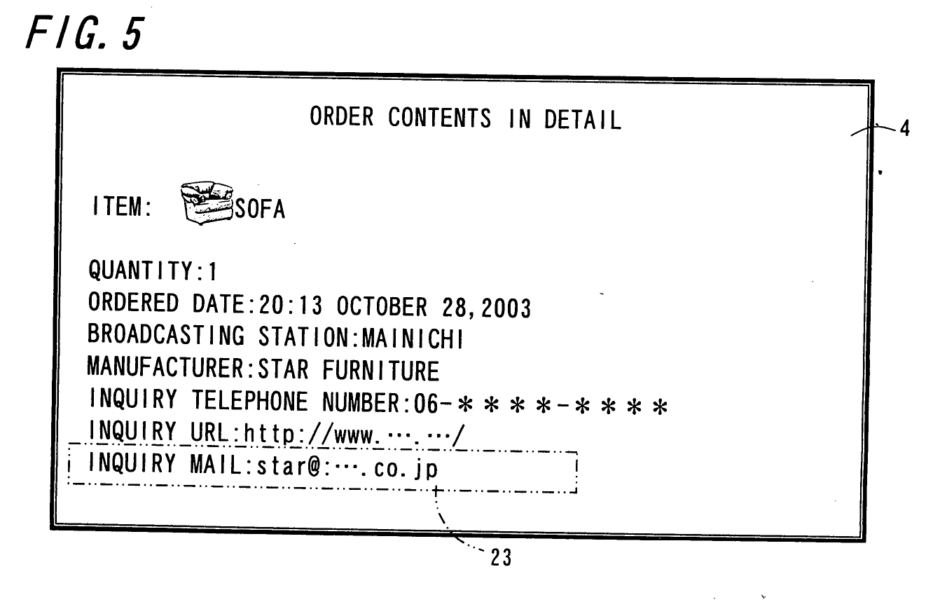

FIG. 4 is a diagram illustrating an order confirmation screen, which is one example of a screen wherein an order list is displayed. FIG. 5 is a diagram illustrating one example of a screen on which order contents are displayed in detail. It is possible to voluntarily output the item information, additional information, present time and date, and name of the broadcasting station which are saved in the memory 14. It is also possible to voluntarily output the item information, additional information, present time and date, and name of the broadcasting station saved in the memory 14 when the item is ordered. For instance, on the condition that the main menu screen is displayed, it is possible for the operator to select a history menu. The history menu is selected, and it is possible for the item information, additional information, present time and date, and name of the broadcasting station saved in the memory 14 to be displayed, that is, outputted on the display 4.

Specifically, after the operator ordered the item, the operator selects the history menu out of the main menu, and the order list shown in FIG. 4 is outputted on the display 4. That is, based on output signals outputted from the switch operation control unit 13 by pushing the history menu, the CPU 15 outputs the item information, present time and date, name of the broadcasting station saved in the memory 14 on the display 4. The order list represents that, for instance, “sofa” and “electric bulb” are ordered. Out of these items, it is shown that the “sofa” is introduced in a program of a broadcasting station “Mainichi” and that, at the time of “2003/10/28 20:13”, “1” unit of “sofa” is ordered. It is shown that “electric bulb” is introduced in a program of a broadcasting station “Asahi” and that at the time of “2003/9/23 21:35”, “4” units of “electric bulb” are ordered.

The operator selects “sofa” on the condition that the order list is shown, then, based on the output signals, the CPU 15 outputs information representing the order contents in detail on the display 4 as shown in FIG. 5. More specifically, it is outputted on the display 4 that, for instance, a pattern of the sofa as the item, and a word; “sofa”. Further, it is outputted on the display 4 that the order quantity of the item: “1”, the order time and date: “20:13 Oct. 28, 2003”, the broadcasting station: “Mainichi”, the manufacturer: “Star Furniture”, the telephone number for inquiry: “06-****-****”, the URL for inquiry: “http://www. . . . . . . . /”, and the mail address for inquiry: “star@;, . . . .co.jp”. Therefore, the operator can confirm the order contents shown on the display 4.

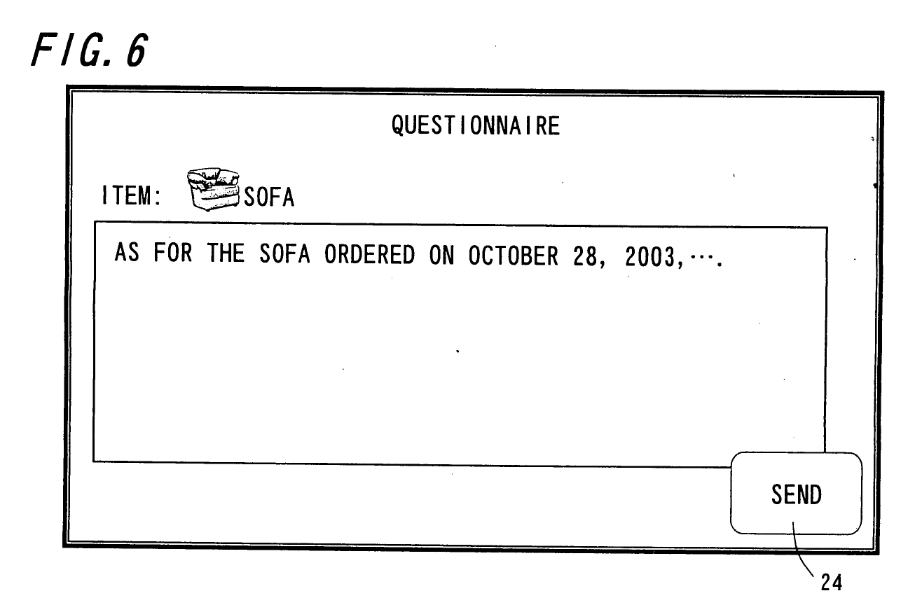

FIG. 6 is a diagram illustrating one example of questionnaire/opinion sending screen. As for the ordered item, at least one of the telephone number for inquiry, the URL for inquiry, and the mail address for inquiry is used, and it is possible to inquire of a manufacturer or sales outlet for the item. For instance, with the use of the remote control 20, a cursor 23 is pointed to a display region including the mail address for inquiry, further a decision button (not shown) on the remote control 20 or the like is operated, and it is possible to transit to the questionnaire/opinion sending screen shown in FIG. 6. On the condition that the questionnaire/opinion sending screen is shown on the display 4, it is possible to input with the use of the remote control 20 or the like, contents to be inquired: “As for the sofa ordered on Oct. 28, 2003, . . . .” or the like. Data of these contents to be inquired is stored in the RAM 17 or the like. After the operator inputs the contents to be inquired as above, a sending switch 24 is pressed, and it is made possible to send these contents to be inquired to the manufacturer.

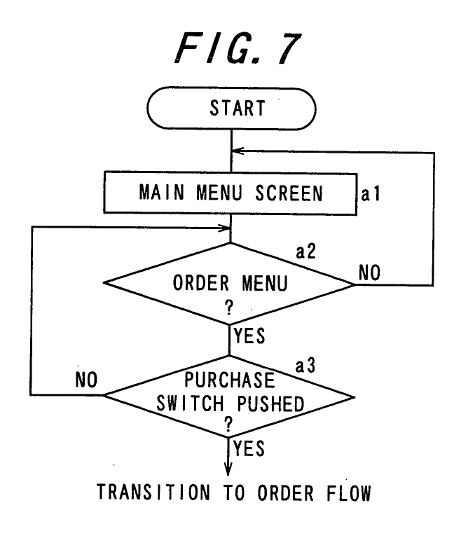

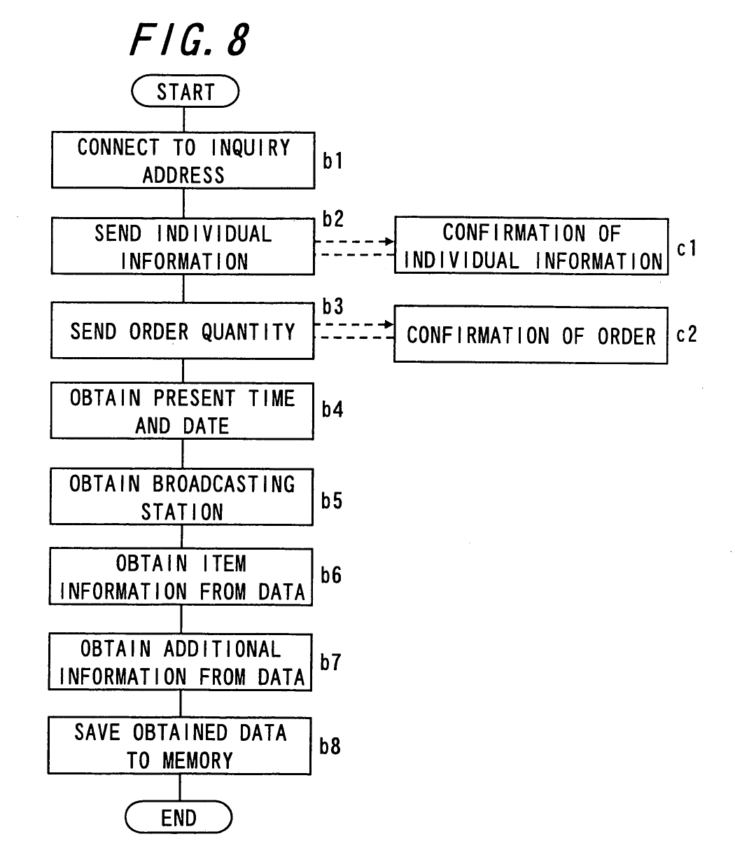

The FIG. 7 is a flowchart illustrating a preparatory operation of the CPU 15 for transiting to an item order process. This process starts on the condition that main powers of the display 4 and the receiver 2 are put on, that is, ON. A control main constituent for this is the CPU 15. After the process starts, at step a1, the CPU 15 outputs the main menu screen on the display 4. Next at step a2, the CPU 15 determines whether an order menu is selected or not, based on the output signals from the switch operation control unit 13. When being determined that the order menu is selected at this point, step a3 follows. At step a3, the CPU 15 determines whether the purchase switch 21 is pressed or not, based on the output signals from the switch operation control unit 13. When being determined that the purchase switch 21 is pressed, a flow of ordering an item as shown in FIG. 8 follows. When being determined at step a2 that an order menu is not selected, it returns to step a1. When being determined at step a3 that the purchase switch 21 is not pressed, it returns to step a2.

The FIG. 8 is a flowchart illustrating an operation of the CPU 15 to order an item. This process starts when the main powers of the display 4 and the receiver 2 are put on, that is, ON, on condition that the command signals corresponding to the operator's commands from the switch operation control unit 13 (the command signals corresponding to the purchase switch 21) are outputted. A control main constituent for this is the CPU 15. After the process starts, step b1 follows. The CPU 15 allows the receiver 2 to be connected electrically to the inquiry address through, for example, a telephone line or the like. Next, step b2 follows. The CPU 15 sends individual information to the inquiry address. The individual information includes an individual address, name, contact address, and numbers of a credit card to make payments for the item or the like.

At a place of the inquiry address, the individual information is confirmed and processed, on the condition that the individual information is received, and the result is sent back as a reply (step c1). At step c1, the individual information is recognized, then, step b3 follows, and the CPU 15 allows the intended item and the order quantity of the item to be sent to the inquiry address. Thereafter, at the place of the inquiry address, an acceptance of the order is confirmed and processed, on the condition that the item and the order quantity of the item is received, and the result is sent back as a reply (step c2). Then, step b4 follows. The CPU 15 obtains the present time and date with the use of an IC for watch (not shown) or the like, and the CPU 15 makes the RAM 17 store them temporarily.

Next, step b5 follows. The CPU 15 makes the RAM 17 temporarily store a name of the broadcasting station which introduced the ordered item. Next, step b6 follows. The CPU 15 makes the RAM 17 temporarily store the item information, based on the text information. Next, step b7 follows. The CPU 15 makes the RAM 17 temporarily store the additional information, based on the text information. Thereafter, step b8 follows. The CPU 15 makes the memory 14 store the present time and date, name of the broadcasting station, item information and the additional information which are temporarily stored, and then the process ends.

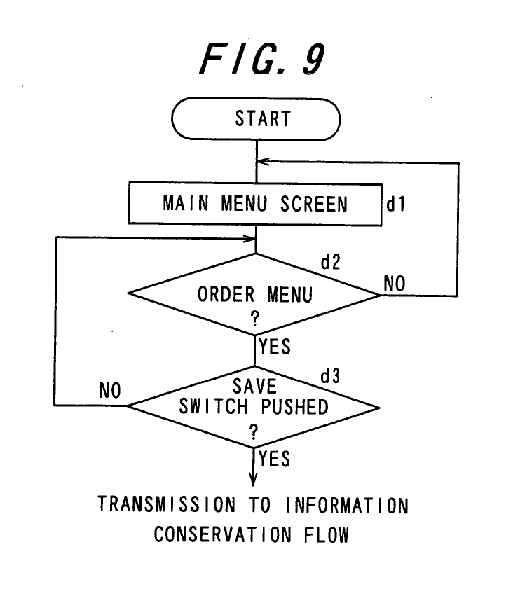

FIG. 9 is a flowchart illustrating an operation for transiting to an information conservation process of the CPU 15. Before the item is ordered, it is also possible to make the memory 14 store the present time and date, the name of the broadcasting station, the item information, and the additional information. On condition that the main powers of the display 4 and the receiver 2 are put on, that is, ON, a process shown in FIG. 9 starts. A control main constituent for this is the CPU 15. After the process starts, at step d1, CPU 15 outputs the main menu screen on the display 4. Next, at step d2, the CPU 15 determines whether the order menu is selected or not, based on the output signals from the switch operation control unit 13.

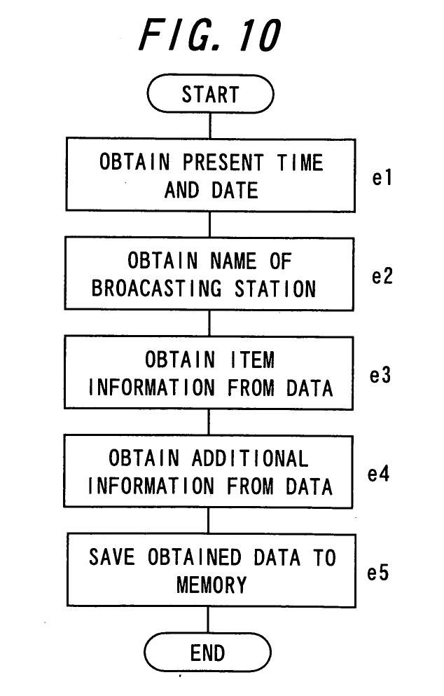

When being determined that the order menu is selected at this point, step d3 follows. At step d3, the CPU 15 determines whether the saving switch 22 is pressed or not, based on the output signals from the switch operation control unit 13. When being determined that the saving switch 22 is pressed, an information conservation flow shown in FIG. 10 follows. At step d2, when being determined that the order menu is not selected, it returns to step d1. At step d3, when being determined that the saving switch 22 is not pressed, it returns to step d2.

FIG. 10 is a flowchart illustrating an operation of the CPU 15 to save obtained data in the memory 14. When the main powers of the display 4 and the receiver 2 are put on, that is, ON, on the condition that the command signals corresponding to the operator's commands (command signals corresponding to the saving switch 22) are outputted from the switch operation control unit 13, the process starts. A control main constituent for this is the CPU 15. After the process starts, step e1 follows. The CPU 15 obtains the present time and date with the use of an IC for watch or the like and the CPU 15 makes the RAM 17 store the present time and date temporarily. Next, step e2 follows. The CPU 15 makes the RAM 17 temporarily store a name of the broadcasting station wherein the intended item is introduced. Next, step e3 follows. The CPU 15 makes the RAM 17 temporarily store the item information, based on the text information. Next, step e4 follows. The CPU 15 makes the RAM 17 temporarily store the additional information, based on the text information. Thereafter, step e5 follows. The CPU 15 makes the memory 14 store the present time and date, name of the broadcasting station, item information and additional information which are temporarily stored, then, the process ends. Therefore, it is possible for the operator to voluntarily output the name of the broadcasting station, item information and additional information which are saved in the memory 14, and after confirming the contents, the item can be ordered.

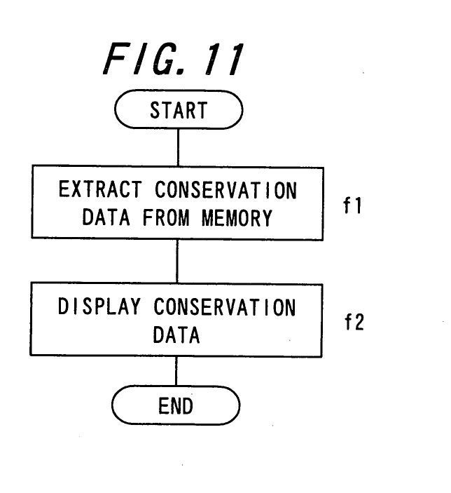

FIG. 11 is a flowchart illustrating an operation of CPU 15 to display conservation data. In a situation that the present time and date, the name of the broadcasting station, the item information, and the additional information are stored in the memory 14, on condition that, for instance, the history menu is pressed, the process starts. After the process starts, step f1 follows. The CPU 15 extracts the conservation data corresponding to the operator's operation from the memory 14. The conservation data includes the data of at least one of the present time and date, the name of the broadcasting station, the item information, and the additional information. Next, step f2 follows. At this point, the CPU 15 makes the extracted conservation data be shown on the display 4, and thereafter, the process ends.

According to the digital broadcasting receiving apparatus 1 described above, the memory 14 realized by a hard disc drive or the like stores the program list of a program in which the item is introduced, and the item information every time the item is ordered. It is possible by the display 4 to voluntarily output the program list and item information which are saved in the memory 14. Thus, the memory 14 automatically stores the program list of the program in which the item is introduced, and the item information every time the item is ordered. Then, the following effects are obtained. It is possible for an operator to eliminate troubles that the orderer writes down all the item information and the program list, and moreover, to obtain the item information and the program list most surely without fail.

In addition, after the item is ordered, it is possible to output the item information and the program list at any time. Therefore, the operator can recognize the information of the ordered item before the item is delivered or when the item is delivered. Since the information of the ordered item can be recognized by outputting it at any time, even when a mistake in an order placement of the item by the orderer is found, it is possible to cancel the order of the item without delay. Even when a mistake in an order placement of the item by a item provider is found, it is possible to recognize the order mistake by comparing and confirming the information of the ordered item and the actual item.

Further, according to the digital broadcasting receiving apparatus 1 of the embodiment, since the information of the item includes the order quantity of the item, the orderer can confirm whether the quantity of the delivered item is correct or not by recognizing the information of the item outputted by the display 4. Further, since the information of the item includes the inquiry address for the item, when it is necessary to inquire unclear points, breakdowns and others about the ordered item, it is possible to give a quick access to the inquiry address. It is also possible to confirm the name of the broadcasting station, broadcasting day, and broadcasting hours, and to recognize the ordered item so as not to forget.

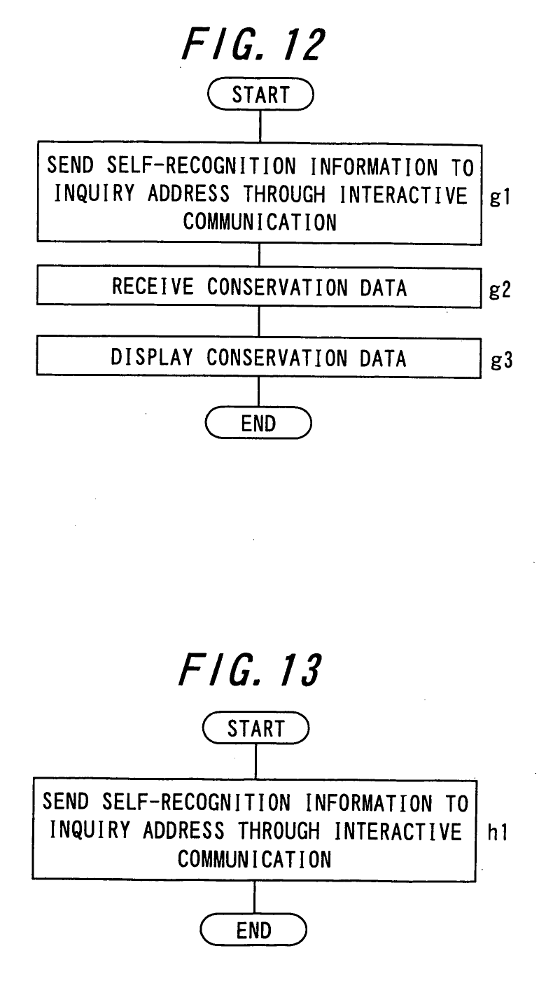

FIG. 12 is a flowchart illustrating another operation of the CPU 15 to display conservation data. On the precondition that interactive communication with the inquiry address is possible, and on condition that, for instance, the history menu is pressed by the operator, the process starts. After the process starts, step g1 follows. The CPU 15 sends the self-recognition information to the inquiry address. Next, step g2 follows. The conservation data corresponding to the sent self-recognition information is received. The conservation data is stored in, for instance, a server of the inquiry address. Thereafter, step g3 follows. The CPU 15 outputs the conservation data on the display 4, and the process ends. In the digital broadcasting receiving apparatus of the embodiment, the RAM 17 and the server correspond to the storing means. Therefore, it is possible to eliminate an external memory such as a hard disc drive.

FIG. 13 is a flowchart illustrating an operation of the CPU 15 to send information to the inquiry address. On the precondition that the interactive communication with the inquiry address is possible, and on condition that, for instance, the history menu is pressed by the operator, the process starts. After the process starts, step h1 follows. The CPU 15 sends the self-recognition information to a server or the like of the inquiry address, and the process ends.

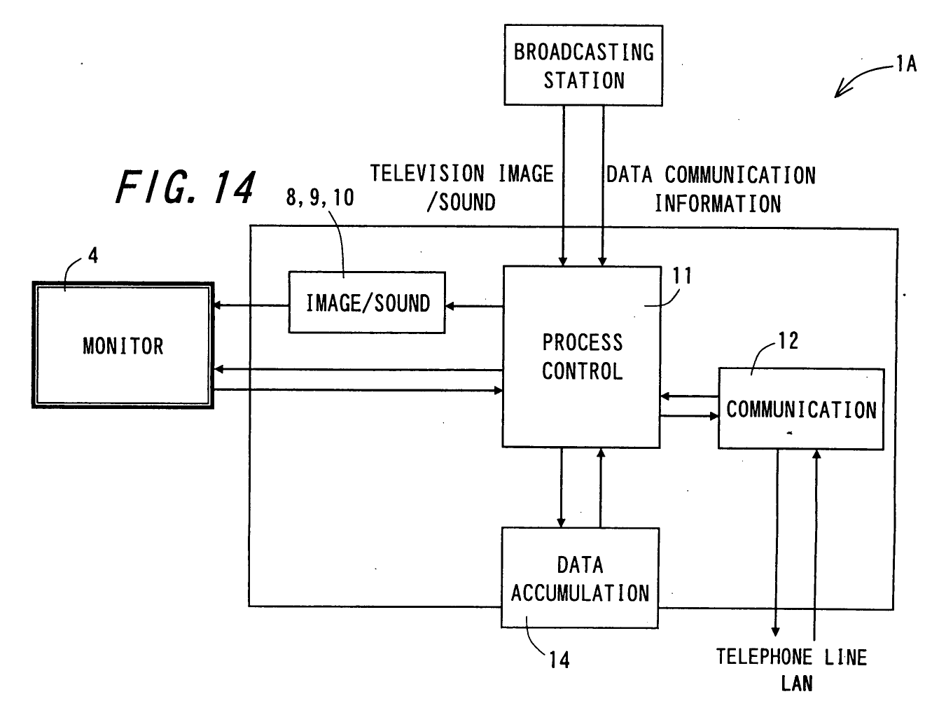

FIG. 14 is a block diagram schematically illustrating an electric structure of a digital broadcasting receiving apparatus 1A of another embodiment of the invention. In this regard, the same components as those of the digital broadcasting receiving apparatus 1 of the above-mentioned embodiment are given the same number, and the detailed description is omitted. In the digital broadcasting receiving apparatus 1A of another embodiment, especially, the switch operation control unit is omitted. That is, the digital broadcasting receiving apparatus 1A has such a structure that the function of the switch operation control unit is integrated in the process control unit 11. According to such structure, all operations can be controlled by the CPU of the process control unit 11. For instance, when operating the digital broadcasting receiving apparatus only with a remote control, without the use of the touch panel, this structure can be applicable.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. An order confirmation apparatus comprising:
receiving means for receiving broadcast waves containing program addition information added to a program to be provided;
item ordering means for ordering an item which is introduced in a program on the broadcast waves received by the receiving means;
storing means for storing the program addition information for the program in which the item is introduced and information of the item in accompaniment with order of the item, by the item ordering means; and
output means capable of outputting the program addition information stored in the storing means and information of the ordered item.

2. The order confirmation apparatus of claim 1, wherein the information of the item includes an order quantity of the item.

3. The order confirmation apparatus of claim 2, wherein the information of the item further includes an inquiry address about the item.

4. The order confirmation apparatus of claim 1, wherein the program addition information includes a name of a broadcasting station, a broadcasting date and broadcasting hours.

5. The order confirmation apparatus of claim 2, wherein the program addition information includes a name of a broadcasting station, a broadcasting date and broadcasting hours.

6. The order confirmation apparatus of claim 3, wherein the program addition information includes a name of a broadcasting station, a broadcasting date and broadcasting hours.

7. An order confirmation method comprising:
an item ordering step of receiving broadcast waves containing program addition information added to a program to be provided and ordering an item introduced in the program of the received broadcast waves;
a storing step of storing the program addition information of the program introducing the item, and information of the item, in accompaniment with order of the item at the item ordering step; and
an outputting step of outputting the program addition information and information of the ordered item stored at the storing step.
